(19) United States
(12) Patent Application Publication
(10) Pub. No.: US 2008/0130470 A1
(43) Pub. Date: Jun. 5, 2008

(54) Optical Pick-Up Unit

(75) Inventor: John A. Harold-Barry, Southampton (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/556,111

(22) PCT Filed: May 6, 2004
(86) PCT No.: PCT/IB04/01677

§ 371 Date: Nov. 8, 2005

(30) Foreign Application Priority Data
May 13, 2003 (GB) 0310927.9

(51) Int. Cl. G11B 7/00

(52) U.S. Cl. 369/112.23

(57) ABSTRACT

The present invention provides for an optical pick-up unit having a lens arrangement for driven movement in the direction of an optical disk, a counterweight mass member mounted in a manner so as to be moveable in the direction of the disk when the optical pick-up unit experiences an impact force, such as, for example, if it is dropped, the mass and lens arrangement each having respective engagement formations arranged to achieve contact during movement of the lens arrangement and the mass member in the relative direction of the disk such contact serving to arrest the movement of the lens arrangement in the said relative direction of the disk.

The present invention relates to an optical pick-up unit particularly for use with an optical disk drive of, for example, a portable device.

Optical pick-up units are found within optical disk drives and generally include a lens arrangement which can be moved in radial direction relative to an optical disk mounted approximate thereto. The lens arrangement is also arranged to be driven for controlled movement in a focusing direction, towards, and away from, the surface of the optical disk in an attempt to achieve constant accurate focusing of the laser beam generated within the optical pick-up unit upon the tracks of the optical disk.

This degree of freedom of movement in the focusing direction of the lens arrangement can however prove disadvantageous in that, under conditions of impact and which can develop sudden acceleration/deceleration, the shock force experienced by the optical pick-up unit will cause lens arrangement to move in the focusing direction relative to the disk. If such force is great enough, the lens arrangement can disadvantageously impact the surface of the disk. Such impact can lead to problems arising from damage to the disk and/or the lens arrangement and can also disadvantageously interrupt the writing of information to, or the retrieval of information from, the optical disk.

The mechanical tolerances allowed for the disc can also serve to lead to a reduction in the distance of separation between the lens arrangement and the surface of the disk which can likewise increase the likelihood of impact between the disk and lens arrangement.

The present invention seeks to provide for an optical pick-up having advantages over known such units.

In particular, the present invention seeks to provide for an optical pick-up including means serving to prevent contact between the lens arrangement and the optical disk.

According to the present invention there is provided an optical pick-up unit having a lens arrangement arranged for driven movement in the direction of optical storage media, a mass member mounted in a manner so as to be moveable in the direction of the optical storage media when the optical pick-up unit experiences an impact force, the mass and lens arrangement each having engagement formations arranged to achieve contact during movement of the lens arrangement and the mass member in the direction of the storage media and so as to limit the relative movement of the lens arrangement in the direction of the storage media.

Advantageously therefore, an impact experienced by the optical pick-up unit will not only serve to move the lens arrangement in the relative direction of the optical storage media, but will likewise move the mass member in the same relative direction. This movement can then, by way of the engagement formations, serve advantageously to arrest the relative motion of the lens arrangement towards the optical storage media, and also advantageously start to move the lens arrangement away from the surface of the optical storage media.

Contact between the lens arrangement and the surface of the optical storage media can therefore advantageously be prevented by means of a relatively simple mechanical coupling arrangement.

Preferably, the said respective engagement formation comprises a lever arrangement.

Advantageously, the lever arrangement is connected to the mass member for movement therewith.

The present invention can therefore provide a relatively simple mechanical arrangement in which a lever is driven by movement of the mass member so as to engage, in a moveable manner, an engagement formation associated with the lens arrangement.

Through use of such a relatively simple mechanical arrangement, the resistance to potential contact between the lens arrangement and the surface of the optical storage media can advantageously be prevented irrespective of whether the optical pick-up unit is in a powered state.

Also, the engagement formations can advantageously be arranged to remain out of contact unless an impact force is experienced such that normal operation of the optical pick-up unit is not prejudiced by the inclusion of features according to the present invention.

Preferably, the engagement formation associated with the mass member is arranged to move to achieve contact with the engagement formation associated with the lens arrangement through contact with a supporting member mounted to the chassis of the optical pick-up unit.

Advantageously, the contact with the supporting member serves to effect pivotal movement of the engagement formation extending from the mass member during the movement thereof.

Such pivotal movement advantageously not only serves to arrest movement of the lens arrangement but can further serve to move the lens arrangement in a direction opposite to that of the optical storage media.

In this manner, the contact of the supporting member advantageously provides for a pivot point of the engagement formation associated with the mass member, which pivot point is provided at a predetermined location between the mass member and the lens arrangement.

The engagement formation associated with the mass member is therefore advantageously arranged to function as a lever.

Yet further, the contact between the respective engagement formations of the mass member and the lens arrangement are arranged to achieve contact after movement of the mass member through a predetermined distance.

According to a further particular aspect, the optical pick-up unit can include biasing means arranged to bias the mass member against relative movement in the direction of the optical storage media for impact forces below a threshold level.

Preferably, the biasing means comprises a spring arrangement serving to preload the mass member against an endstop member.

Advantageously damping means are provided so as to dampen movement of the mass member.

In one particular arrangement, the optical storage media comprises an optical disk and the optical pick-up unit is advantageously employed within an optical disk drive such as that employed within a portable device.

The invention is described further hereinafter, by way of example only, with reference to the accompanying drawings in which:

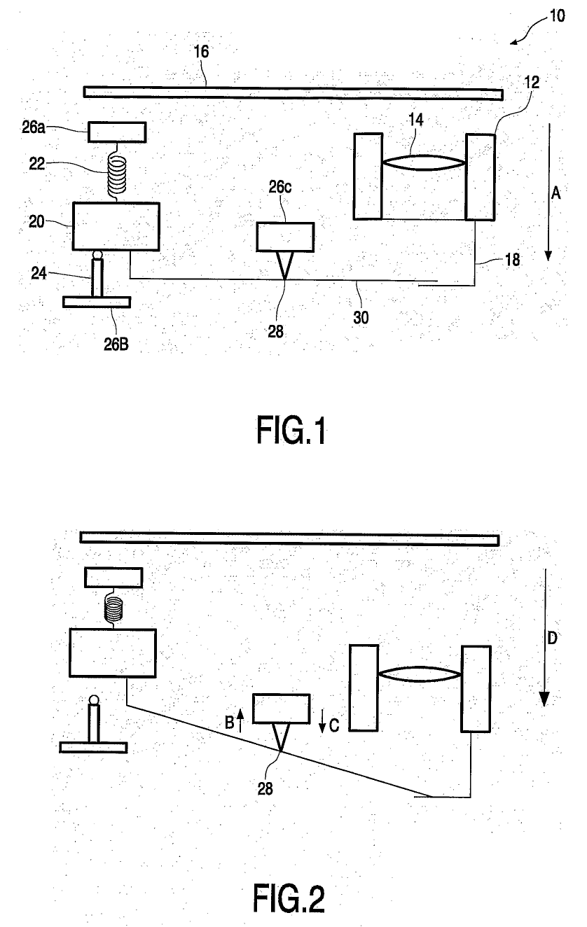

FIG. 1 is a schematic side view of an optical pick-up unit embodying the present invention; and

FIG. 2 is a view of the optical pick-up unit similar to that of FIG. 1 but with the optical pick-up unit having experienced an impact force.

As will be appreciated, the present invention is concerned with preventing damage to, for example, an optical disk and lens arrangement of an optical disk drive, should the device within which the disk drive is mounted experience sudden acceleration and/or deceleration due to an impact such as that experienced when dropped.

Turning to FIG. 1, there is presented a schematic side view of an optical pick-up unit 10 of an optical disk drive and which includes a lens arrangement 12 including a lens 14 which serves to focus a laser beam onto the surface of an optical disk 16.

The lens arrangement 12 is arranged to be driven in a radial direction relative to the disk 16 and, more importantly with regard to the present invention, in a focusing direction towards, and away from, the optical disk 16 so as to achieve accurate and consistent focusing of the laser beam on the surface of the optical disk 16.

In accordance with the present invention, the lens arrangement 12 has an engagement formation associated therewith which, as illustrated schematically in the drawing, comprises an arm 18.

Also mounted within the optical pick-up unit 10 illustrated in FIG. 1 is a counterweight mass member 20 which in FIG. 1 is preloaded by means of a compression spring 22 so as to be bedded against an endstop 24. As is discussed in further detail below, the compression spring 22 serves to preload the mass member 20 such that it can only move off the endstop 24 if an impact force of a sufficient predetermined magnitude is experienced by the optical pick-up unit 10.

The compression spring 22 and endstop 24 are mounted to elements 26a, 26b of the chassis of the optical pick-up 10. Also mounted to an element 26c of the chassis of the optical pick-up unit 10 is a support extension which presents at its end tip a pivot point 28.

Extending from the mass member 20, and in the direction of the arm 18 of the lens arrangement 12 is an engagement formation associated with the mass member 20 and which in the illustrated example comprises a lever arm 30. The lever arm 30 is in contact with the pivot point 28.

FIG. 1 illustrates merely a contact between the lever arm 30 and the pivot point 28 but it will be appreciated that any appropriate form of coupling engagement can be provided as an alternative to mere contact between the two elements 28, 30.

As illustrated in FIG. 1, the arm 18 associated with the lens arrangement 14 and the lever arm 30 associated with the mass member 20 extend towards each other so as to overlap but with a gap therebetween.

Arrow A within FIG. 1 illustrates the direction of a shock force experienced by the optical pick-up unit 10 which, as an example, can arise through a device within which the optical pick-up 10 is mounted at being dropped.

In view of the inertia of the lens arrangement 14 and the mass member 20, both of these elements move in a relative direction towards the optical disk 16 upon the optical pick-up unit 10 experiencing a shock force A above a threshold value.

As noted above, the shock force A has to be above a threshold value so as to overcome the biasing force offered by the compression spring 22 and which serves to seat the mass member 20 on the endstop 24.

Assuming such shock force A is above the said threshold value, the disc 16 and chassis 26 of the optical pick-up unit will therefore move downwardly in the direction of Arrow A in the drawing and, as noted above, the inertia of the lens arrangement 12 and the mass member 20 will effectively cause both the lens arrangement 12 and the mass member 20 to move relative to the optical disk 16 and in the direction thereof.

As identified in prior-art arrangements, such relative movement can disadvantageously lead to contact between the lens arrangement 12 and the surface of the optical disk 16 by which either or both of those elements can experience damage.

However, the inclusion of the mass member 20 and the lever arm arrangement 18, 28, 30 in accordance with the present invention serves to advantageously prevent such contact.

Reference is now made to FIG. 2 in which the same elements of FIG. 1 are illustrated but in which the lever arm arrangement 18, 28, 30 has come into play so as to arrest movement of the lens arrangement 12 relative to the optical disk 16 and in the direction thereof. Indeed the lever arm arrangement serves to move the lens arrangement 12 in a direction away from the optical disk 16.

As will be appreciated from reference to FIG. 2, the impact force A, being great enough to unseat the mass member 20 from its endstop 24, serves to move the mass member in the upward direction relative to the disk 16 as shown in FIG. 2 and which likewise serves to cause the lever arm 30 to pivot about the pivot point 28 in a clockwise direction. Such pivoting continues and serves to reduce the separation between the pivotal end of the lever arm 30 and the arm 18 extending from the lens arrangement 12 until such time as contact is achieved between the lever arm of the mass member 20 and the arm 18.

Subsequent to such contact as illustrated in FIG. 2, and through continued movement of the mass member 20 upwardly in the direction as shown in FIG. 2, the engagement between the lever arm 30 and the arm 18 of the lens arrangement 12 serves to arrest the relative upward movement of the lens arrangement 12 and in fact commences relative downward movement of the lens arrangement 12 as the mass member 20 continues in its relative upward movement.

Such relative movement is illustrated further with reference to the arrows shown in FIG. 2.

Arrow B illustrates the upward movement of the mass member 20 relative to the chassis and likewise the clockwise movement of the portion of the lever arm 30 to the left of the pivot point 28, whereas arrow C illustrates the clockwise movement of the portion of the lever on 30 to the right of the pivot point 28 and which, once that right-hand portion of the lever arm 30 contacts the arm 18 associated with the lens arrangement 12, serves to move the lens arrangement 12 in a downward direction relative to the chassis and as indicated by arrow D which therefore prevents contact with the surface of the optical disk 16.

Although not illustrated, damping means can advantageously be provided so as to prevent the mass member 20 bouncing on its endstop 24.

By means of the counterweight within the optical pick-up unit as illustrated in the drawings, relative motion of elements within the chassis of the optical pick-up unit 10 can advantageously be employed, by way of a simple lever arrangement, to prevent potentially damaging impact between the lens arrangement and the optical disk.

Of course, it will be appreciated that the invention is not restricted to the details of the foregoing embodiment.

For example, any appropriate engagement formations can be associated with the counterweight mass and the lens arrangement and the illustrated embodiment is simplified for the purposes of clarity.

Also, the gap providing for the initial separation between the overlapping ends of the lever arm 30 and the arm 18 can be provided in an accurately predetermined manner so as to allow for a predetermined degree of movement of the counterweight mass before it starts to affect the motion of the lens arrangement relative to the chassis and the optical disk.

The gap allowing for an initial unconnected state between the engagement formations serves the purpose that the lens 12 does not carry additional mass which might otherwise reduce performance.

The gap could be located the other side of the pivot from that shown and the lens 12 and mass 20 could be connected by a hinged lever that only contacts the point 28 in the case of experiencing an impact force.

It may also be advantageous to employ a spring member offering a nonlinear return force. If for example it is made from an arch shape with the ends prevented from moving and with the mass 20 mounted at the top of the arch, a high force is required to bend the arch. Once bent beyond a certain point the force reduces dramatically. This would result in mass 20 taking longer to return to endstop 24 and protecting the lens from after-shocks.

In view of the potentially high shocks expected, perhaps in the order of 1000 G, the lever and mass can be of an annular configuration around the lens. This arrangement could for example employ a plurality of levers, or a cone, which could also comprise a nonlinear spring as above.

1. An optical pick-up unit having a lens arrangement arranged for driven movement in the direction of optical storage media, a mass member mounted in a manner so as to be moveable in the direction of the optical storage media when the optical pick-up unit experiences an impact force, the mass and lens arrangement each having engagement formations arranged to achieve contact during movement of the lens arrangement and the mass member in the direction of the storage media and so as to limit the relative movement of the lens arrangement in the direction of the storage media.

2. A unit as claimed in claim 1, wherein the said respective engagement formations include a lever arrangement.

3. A unit as claimed in claim 2, wherein the lever arrangement is connected to the mass member for movement therewith.

4. A unit as claimed in claim 1, wherein the engagement formations are arranged to remain out of contact unless a predetermined threshold impact force is exceeded.

5. A unit as claimed in claim 1, wherein the engagement formation associated with the mass number is arranged to move to achieve contact with the engagement formation associated with the lens arrangement through contact with a supporting member mounted to the chassis of the optical pick-up unit.

6. A unit as claimed in claim 5, wherein the contact with the supporting member serves to provide for pivotal movement of the engagement formation extending from the mass member during the movement thereof.

7. A unit as claimed in claim 6, wherein the said contact comprises rotatable connection between the engagement formation extending from the mass member and the supporting member.

8. A unit as claimed in claim 1, wherein the motion of the engagement formation serves to move the lens arrangement in a direction away from the optical storage media.

9. A unit as claimed in claim 1, wherein the engagement formations of the mass member and lens arrangement are arranged to achieve contact after movement of the mass member through a predetermined distance.

10. A unit as claimed in claim 1 and including biasing means arranged to bias the mass member against movement in the relative direction of the optical storage media for impact forces below a threshold magnitude.

11. A unit as claimed in claim 10, wherein the biasing means comprises a spring arrangement serving to preload the mass member against an endstop member.

12. A unit as claimed in claim 1 and including movement of the mass member.

13. A optical disk drive including an optical pick-up unit as claimed in claim 1.
